(19) United States
(12) Patent Application Publication
(10) Pub. No.: US 2018/0124457 A1
(43) Pub. Date: May 3, 2018

(54) SYSTEM AND METHOD FOR DIGITAL TELEVISION BOOT AND PACKAGE SCANNING

(71) Applicants: Jamdeo Canada Ltd., Oakville (CA); Hisense Electric Co., Ltd., Qingdao (CA); Hisense USA CORP., Suwanee, GA (US); Hisense International Co., Ltd., Qingdao (CN)

(72) Inventors: Tong CHEN, Oakville (CA); Mikhail SHOYKHER, Oakville (CA); Gregory BURDZINSKI, Oakville (CA)

(73) Assignees: Jamdeo Canada Ltd., Oakville (CA); Hisense Electric Co., Ltd., Qingdao (CN); Hisense USA CORP., Suwanee, GA (US); Hisense International Co., Ltd., Qingdao (CN)

(21) Appl. No.: 15/339,879

(22) Filed: Oct. 31, 2016

(51) Int. Cl. H04N 21/443; H04N 21/442

(52) U.S. Cl. CPC H04N 21/4432; H04N 21/4424

(57) ABSTRACT

The present disclosure relates to electronic devices, processes and systems for configuration and operation of a digital television. In one embodiment, a method for digital television operation includes detecting a command to power up the digital television, running a boot process for the digital television in response to the command, and performing a scan of a first set of applications of the digital television during the boot process. The method also includes presenting a display output at completion of the boot process, and performing a scan of a second set of applications of the digital television following presentation of the display output. Another embodiment is directed to a digital television configured to run a boot process including a scan of a first set of applications, and scan of a second set of applications following presentation of the display output.

### FIELD

The present disclosure relates to electronic devices and applications, and more particularly to processes and configurations of digital television package scanning

### BACKGROUND

Television devices are being designed and developed to provide application and network services in addition to traditional television functions such as decoding and display of broadcast content. Operating systems designed for application network services and applications are typically developed for use on mobile devices, such as mobile phones. The use case for mobile phones is very different than that of a television display device. For example, mobile phones are typically powered on, or off, infrequently and may be left on for days at a time. Power up times of mobile devices and phones of 30 seconds or more are acceptable. Television use typically requires a different scenario, where the television may be powered on and off several times a day. In addition, power up times for a television lasting 30 seconds or more are unacceptable. With the addition of capabilities to a television, power on time can increase.

Because television devices are being used to provide additional types of content and are configured to decode and process digital content, lag times for operation often present frustration on behalf of the user. Accordingly, increasing the speed operation of digital televisions and reducing latency of actions to be completed is desired.

### BRIEF SUMMARY OF THE EMBODIMENTS

Disclosed and claimed herein are methods, devices and systems for presenting digital television operation. One embodiment is directed to a method including detecting, by the digital television, a command to power up the digital television, running, by the digital television, a boot process for the digital television in response to the command and performing, by the digital television, a scan of a first set of applications of the digital television during the boot process. The method also includes presenting, by the digital television, a display output at completion of the boot process, and performing, by the digital television, a scan of a second set of applications of the digital television following presentation of the display output.

In one embodiment, the command to power up the digital television is received by the digital television in one of a low-power and off state of the digital television.

In one embodiment, the boot process loads an operating system of the digital television.

In one embodiment, the scan of the first set of applications is a package scan of a subset of applications to determined capabilities available to the operating system associated with the first set of applications.

In one embodiment, the first set of applications are identified in an executable configuration file stored in memory of the digital television and processed during the boot process.

In one embodiment, presentation of content includes display of image data associated with a source of input of the digital television and wherein presentation of the content indicates operability of the television.

In one embodiment, presentation of content includes presentation of graphical elements associated with one or more applications associated with the first set of applications.

In one embodiment, the second set of applications are non-essential applications.

In one embodiment, running the boot process and performing a scan of the first set of applications are performed are least in part in parallel.

In one embodiment, the method also includes presenting graphical elements by the digital television for the first set of applications and the second set of applications.

Another embodiment is directed to a digital television including a display and a processor coupled to the display. The processor configured to detect a command to power up the digital television, run a boot process for the digital television in response to the command, and perform a scan of a first set of applications of the digital television during the boot process. The processor also configured to present a display output at completion of the boot process, and perform a scan of a second set of applications of the digital television following presentation of the display output.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a graphical representation of a digital television according to one or more embodiments;

FIG. 2 depicts a process for digital television operation according to one or more embodiments;

FIG. 3 depicts a digital television according to one or more embodiments;

FIG. 4 depicts digital television components according to one or more embodiments;

FIG. 5 depicts digital television operation according to one or more embodiments;

FIG. 6 depicts digital television operation according to one or more additional embodiments; and

FIG. 7 depicts a graphical representation of a digital television according to one or more embodiments.

### DETAILED DESCRIPTION OF THE EXEMPLARY EMBODIMENTS

### Overview and Terminology

One aspect of the disclosure is directed to processes for initiating and powering on digital televisions. Digital television design has shifted from presentation of broadcast or video directly input to a digital television to the use of network capabilities (e.g., internet, etc.) and application based content. Use of digital televisions is very different from other devices which provide applications and network capabilities. For example, digital television use typically requires power on and off multiple times a day. Users demand that features of a television are operable without extended delay. Television software and components are typically loaded during power on. Unlike computers or general purpose devices that can include storage of software in a low power state, digital television operation will generally require powering down a central processing unit when the television is turned off or into a low power state that is essentially off. Accordingly, embodiments herein are directed to components and configurations of digital televisions and digital television devices that minimize boot or power on time from receipt of the command to presentation of image content.

According to another embodiment, embodiments are directed to package scanning of applications. In one embodiment, a digital television is provided including a central processing unit configured to execute an operating system to provide television viewing and access to a plurality of applications. According to one embodiment, the digital television may employ multiple stages of package scanning for applications available to the digital television. According to another embodiment, the digital television may be configured to perform one or more operations of the boot process in parallel using multiple processors of a central processing unit.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### Exemplary Embodiments

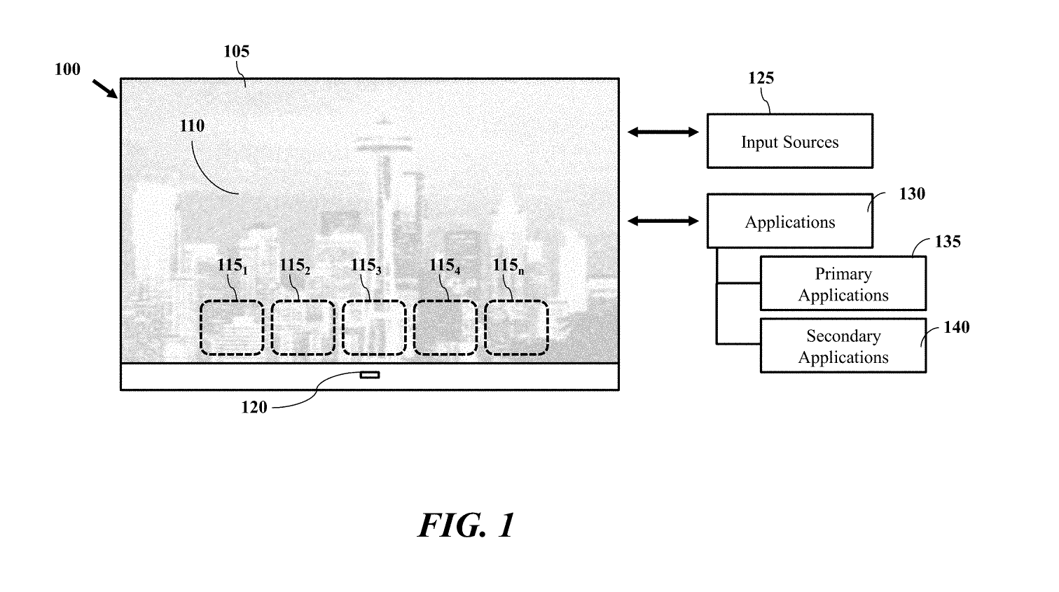

Referring now to the figures, FIG. 1 depicts a graphical representation of a digital television according to one or more embodiments. According to one embodiment, digital television 100 is configured to provide package scanning during a boot operation to improve boot time. Digital television 100 includes display 105 (e.g., LED, LCD, etc.) configured to present image content 110 based on content received by digital television 100. According to one embodiment, digital television 100 may be configured to operate and provide a boot operation including multiple package scanning In one embodiment, application scanning may relate to package scanning during a boot operation of digital television. Package scanning may be performed in multiple stages. In one embodiment, two stages of package scanning are employed to load applications of digital television 100. However, it should be appreciated that additional package scanning stages may be employed. By providing multiple package scanning stages, digital television 100 can load operating system software (e.g., embedded OS) during a boot process without having to scan and parse capabilities of all applications available to the digital television 100. As such, the time required for digital television to present content following a command to power on can be minimized while still allowing for use of the digital television 100.

According to one embodiment, digital television 100 may be configured to run an embedded system to allow for operation of the digital television to present video content and allow for features and operability of one or more applications. The embedded system (e.g., operating system) and applications of the digital television 100 may be initiated based on a boot process described herein. The embedded system of digital television 100 allows for decoding of digital content received from broadcast sources and presentation of digital content received from network sources using one or more applications.

Display 105 relates to a digital television display. It should be appreciated that embodiments may apply to one or more types of display. Display output 110 relates to image content presented by display 105. According to one embodiment, a boot process is configured to present image content from the last tuned source/channel of digital television 100 on power up. According to another embodiment, digital television may be configured to present graphical elements 115₁₋ₙ associated with one or more applications available during or shortly after power on. Graphical elements 115₁₋ₙ are shown as overlay elements over display output 110 in a bottom bar arrangement. According to one embodiment, the presentation format, content and inclusion of graphical elements 115₁₋ₙ may be based on application package scanning during a boot process. According to one embodiment, graphical elements 115₁₋ₙ may be presented to include applications or content associated with applications of a first set of applications scanned during a boot process of digital television 100. In certain embodiments, elements and content of graphical elements 115₁₋ₙ may be based on a combination of operating system elements and applications associated with a first package scan.

In FIG. 1, digital television 100 includes power on input 120 which may be activated to provide a power on command. In certain embodiments, digital television 100 is configured to receive remote control commands to power on from a remote control.

FIG. 1 also depicts a representation of digital television components. Input sources 125 represents a plurality of input sources available to provide content to digital television 100. Input sources 125 may relate to directed input sources, such as HDMI, coaxial, video connections, etc. In another embodiment, input sources 125 may relate to network communication terminals that allow for network communication by one or more applications of the digital television 100.

Applications 130 relate to applications stored and executed by digital television 100. These applications may be executed by an operating system of digital television 100. Applications 130 may be listed as programs in an executable program file that be accessed by the operating system of digital television 100. In one embodiment, the boot process or protocol of digital television 100, and an operating system of digital television 100, may specify one or more executable program files to be employed during a power on process. In one embodiment, a boot process of an digital television 100 includes a first program file identifying applications associated with a first application scan, and a second program file identifying applications associated with a first application scan. According to another embodiment, the configuration file, or files, may specify between primary applications 135 and secondary applications 140. In one embodiment, primary applications 135 relate to applications specified to be accessible at power on or shortly thereafter. These may be applications associated with a welcome screen, online menu, or that are required to provide content at startup. Secondary applications 140 may relate to non-essential applications at start up. Non-essential or secondary status may be based on likelihood of use, application type, time to load, etc.

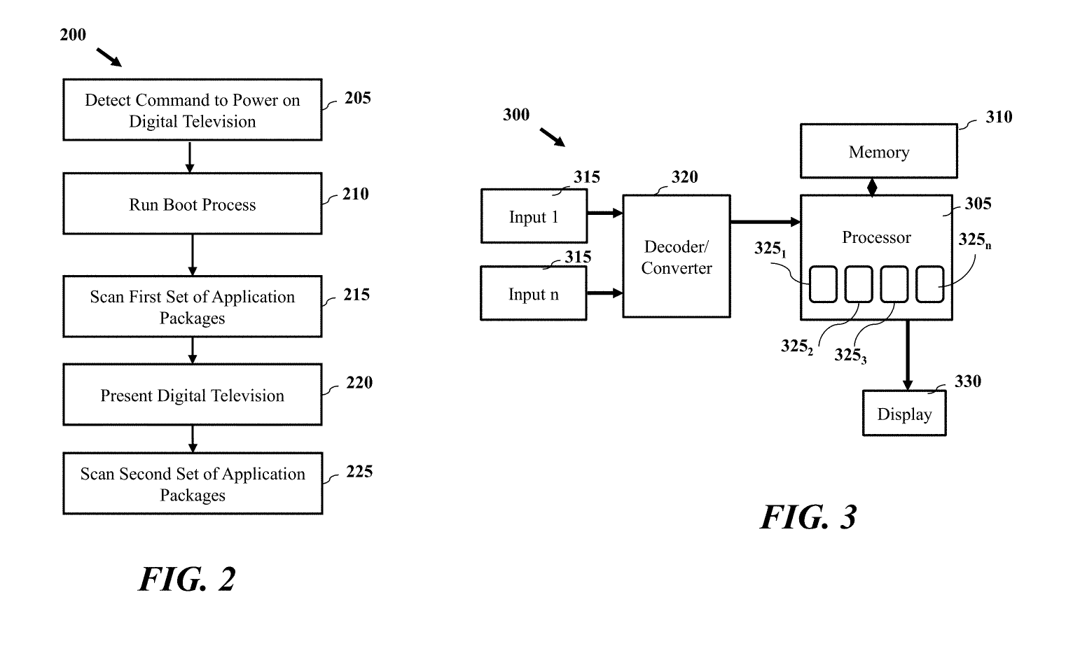

FIG. 2 depicts a process for digital television operation according to one or more embodiments. Process 200 may be employed to boot or power on a digital television (e.g., digital television 100). Process 200 may be performed by a digital television or display device.

Process 200 may be initiated by detecting a command to power up the digital television at block 205. The digital television may receive the command from a remote control or by detecting a press of a power button on the digital television. In one embodiment, the digital television is configured to shut down to stop executing of a central processing unit when the digital television is not in use. The shut down state may be a powerless or substantially powerless state for the digital television. Power on of the digital television may be relative to the shutdown or off state of the digital television. Powering on may require scanning each time the device is powered on.

In one embodiment, the command to power up the digital television is received by the digital television in one of a low-power and off state of the digital television. Once the command is received at block 205, the boot process loads an operating system of the digital television.

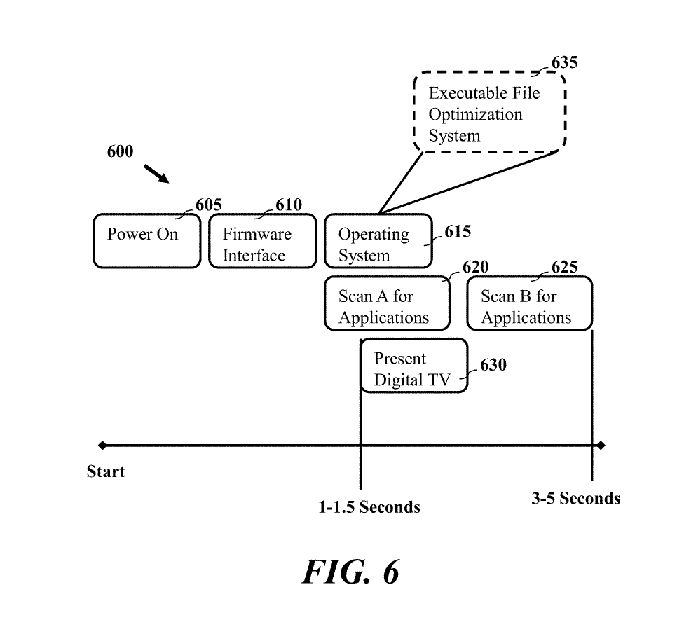

At block 210, in response to the command received at block 205, the digital television will run a boot process. The boot process may determine which software programs or packages to launch and may be based on one or more software images of the digital television and/or one or more program execution files for applications. During the boot process, software must be checked, decompressed and loaded. Decompression and loading of software can introduce delays during startup of the digital television. In order to minimize delay, process 200 includes multiple scans of applications. A boot process according to one or more embodiments is discussed in FIG. 6 below.

According to one embodiment, process 200 employs a two stage scanning process. By way of example, in the first stage (e.g., block 215), packages (applications) that are essential for the system to be operable are scanned. In the second stage (e.g., block 220), the remaining packages on the system are then scanned.

At block 215, the digital television scans a first set of application packages. The first application scan may be performed during the boot process of the digital television, for example during one or more of software decompression and loading. In one embodiment, the scan of the first set of applications is a package scan of a subset of applications to determined capabilities available to the operating system associated with the first set of applications. The package scan, with respect to each application included in the scan, may be employed to identify available system resources, to determine capabilities and provide information stored in memory to the operating system. According to another embodiment, the first set of applications is identified in an executable configuration file stored in memory of the digital television and processed during the boot process.

In one embodiment, block 215 includes a first stage scan to traverses packages found in the system image directories (e.g., those that are pre-defined on a fresh install of the platform or operating system) and searches for packages that are marked as being “core” applications. In one example, the operating system of the digital television marks packages that are essential for the operating system to run as being “coreApps”. In addition, to the “core” packages, a secondary list of essential packages is also read and those packages are also treated as “core” packages in this stage. In one embodiment, core packages may only be pre-installed in the system image and cannot be added with the installation of new/additional packages. As such, core packages may be a fixed set of packages provided by the system. According to one embodiment, the secondary list may be created by the digital television to allow for newly installed packages to be included in the set of “essential” packages.

Each application may be formatted as an application package provided classes of information that can be handled and processed by the application. Scanning the application package can provide the operating system confirmation of available display elements within the digital television. At block 215, scanning the first set of application packages may involve running an executable file stored in memory of the digital television for access by the operating system of the digital television. According to another embodiment, running the boot process at block 210 and performing a scan of the first set of applications at block 215 are performed are least in part in parallel.

In one embodiment, during the scanning process at block 215, packages that are found to meet the scanning criteria are added to the list of available packages on the system. This list is processed by the system package manager and controls what is available to be run on the system. Following the scan at block 215, the system is able to start and be functional with a minimal set of applications available to the end user.

At block 220, process 200 includes presenting a display output at completion of the boot process. The presentation of content includes display of image data associated with a source of input of the digital television and wherein presentation of the content indicates operability of the television. Presentation of content may include presentation of graphical elements associated with one or more applications associated with the first set of applications. Presenting a display at block 200 may involve receiving content (either from a broadcast or set-top box), and decoding the content for display.

At block 225, process 200 includes scanning a second set of application packages applications of the digital television following presentation of the display output. The second set of applications are non-essential applications. By scanning the second set of applications after presentation of digital television at block 220 resources (e.g., computing resources, memory, etc.) of the digital television can be directed to decompression and loading of the operating system and display elements. By delaying the second set of applications, the scanning, decompression and loading of the secondary applications will not affect the time required to present content. According to another embodiment, performing a scan of the second set of applications at block 225 is not merely a time delay of operation, but can be based on the specification of which applications to include in the first and second scans, parallel processing of the first scan, and second scan with one or more other processes of the boot process, and the use of central processing components, such as distribution of the boot process across central processing unit cores.

In one embodiment, scanning at block 225 relates to a second stage scan that begins after the first stage scan at block 215 is completed. According to one embodiment, scanning at block 225 can repeat the first stage scan process with some differences. For example, at block 225 packages which have already been scanned in the first stage are skipped, and scanning criteria is expanded to now include all packages on the system. The output of scanning at block 225 may include an updated list of “runnable” packages available on the system which is used by the system package manager to control what is available to be run on the system. Following scanning at block 225, the system has the full set of applications available to the end user. According to one embodiment, the secondary list for scanning at block 215 can be modified by the system at run-time as needed to include or remove packages that are installed/removed in addition to what is included in the default system image.

According to another embodiment, process 200 may also include presenting graphical elements by the digital television for the first set of applications and the second set of applications. Following the scan of the second set of application packages, applications associated with the second set may be available for use and display by the operating system.

FIG. 3 depicts a digital television according to one or more embodiments. Digital television 300 includes display processor 305, memory 310, inputs 315, decoder 320 and display 330. It should be appreciated that digital television 300 may include one or more additional components not shown in FIG. 3. Digital television 300 is configured to power on using a boot process as described herein.

Inputs 315 relate to physical inputs for receiving video/image content and/or network data for presentation of content on display 330. Decoder/converter 320 receives information and content from inputs 315 which is then formatted and output to processor 305 for presentation on display 330.

Memory 310 may include ROM and RAM memory for operation of digital television 300 and processor 305.

According to one embodiment, processor 305 may be the central processing unit of digital television 300 and include a multiple core configuration having four cores 325₁₋ₙ. According to another embodiment, a boot process may perform some operations in parallel, wherein one multiple cores 325₁₋ₙ may be employed to perform one or more portions of a boot process in parallel.

In one embodiment, multiple cores 325₁₋ₙ of digital television 300 are configured to perform a boot process including starting services and preloading object classes (e.g., Java classes, etc.). According to another embodiment, starting services and preloading object classes may be split among two of more of the multiple cores 325₁₋ₙ. In that fashion, starting services and preloading object classes may be performed in parallel. Service startup is reorganized in such a way, that multiple independent services are started in parallel using multiple cores. Preloading classes is one of the most time-consuming operations. This process may be optimized by splitting the set of classes into multiple subsets and preloading them simultaneously using all available cores. According to another embodiment, operations of digital television 300 may be performed in parallel during package scanning stages. By way of example, as the file system is scanned to look for package during scanning stages, once a package is found it is added to a “queue” of packages that need to be processed. For each available core on the system of multiple cores 325₁₋ₙ, a separate thread is created/run to do package processing. As packages become available in the “queue” each thread removes a package from the queue and processes it. The processing of the package is probably the most expensive and time consuming operation, so paralleling processing by multiple cores 325₁₋ₙ provides significant benefits.

In certain embodiments, digital television 300 may be configured as a smart TV or a cloud/linux based, always connected TV for instant on video-on-demand (VOD) consumption. Digital television 300 may be configured to provide cloud based content in addition to broadcast TV content. Digital television 300 may be configured to communicate by way of a communication network which may be a local network (e.g., LAN, etc.), cellular, internet, or other communication network with one or more cloud based servers for content.

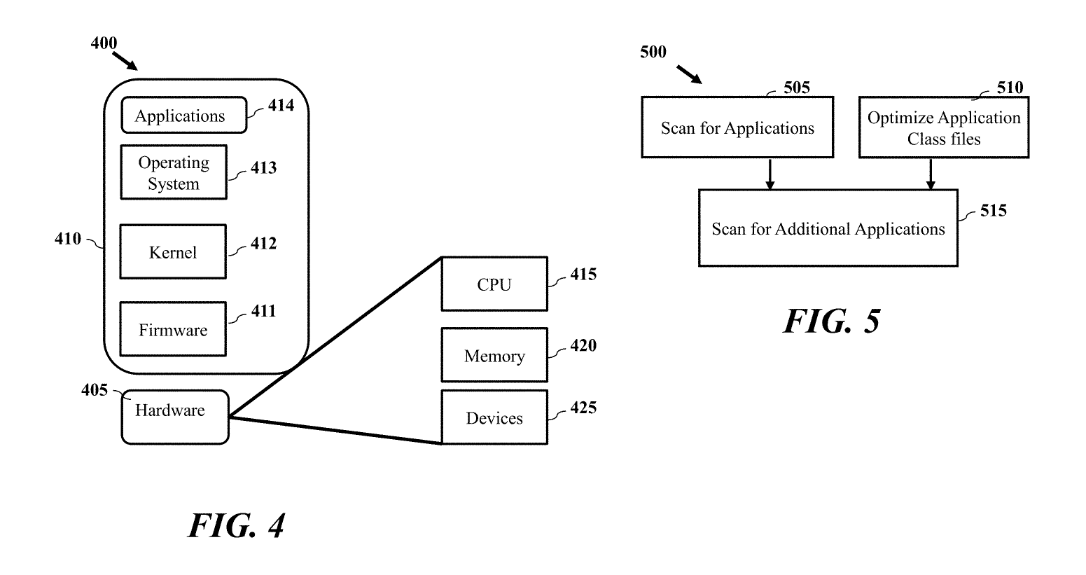

FIG. 4 depicts digital television components according to one or more embodiments. According to one embodiment, a digital television 400 (e.g., digital television 100, digital television 300) includes hardware and software components which interoperate to receive content and data and to control presentation of the content and data by way of a display. According to one embodiment, components of digital television 400 include hardware components 405 and software components 410. According to one embodiment, hardware components 405 and software components 410 are specifically configured to power on digital television.

Hardware components 405 can include central processing unit (CPU) 415, memory 420 and devices 425 (e.g., display, decoders, communications units, etc.). According to one embodiment, powering up hardware components 405 includes a series of actions directed by software components 410. Software components 410 may be described as firmware 411, kernel 412, operating system 413 and applications 414. Firmware 411 may include programs or sets of programs written to read-only memory (ROM) of memory 420 to provide control programs for devices 425. Firmware 411 may include programs used during a boot process. Kernel 412 relates to a set of programs which are part of the digital televisions operating system and used to initialize and manage critical resources like CPU 415, and memory 420. Kernel 412 provides a platform to be able to run other programs, such as applications 414. Operating system 413 provides the base management of the digital television and manages execution of applications 414. Operating system 413 may be responsible for setting up the computer during boot process, managing hardware (via device drivers), and/or providing access to that hardware and other system resources (via application programming interfaces).

According to one embodiment, digital television 400 includes a boot process performed by hardware components 405 and software components 410. According to one or more embodiments, application packages, such as applications associated with first scans and second scans, may be identified by program files stored in memory 420, the program files associated with one or more layers of software components 410. In one embodiment the operating system 413 directs the execution of application packages and scanning of application packages during a boot process based on application execution files stored in memory 420. According to another embodiment, the central processing unit 415 may updated the application packages and scanning order based on changes to the applications, use with a digital television, application size, etc.

FIG. 5 depicts digital television operation according to one or more embodiments. Process 500 relates to scanning applications during a boot process of a digital television (e.g., digital television 100). Process 500 may be initiated during a scan of applications during a boot process, such as scanning in process 200 of FIG. 2. According to one embodiment, process 500 includes steps performed by a central processing unit in parallel, and more particularly, blocks of 500 may be performed by different cores of a central processing unit using threading techniques (e.g., multithreading, etc.). In block 505, process 500 scans for applications associated with a first set of applications. Process 500 may perform block 510 to optimize class files associated with applications in parallel with block 505. In one embodiment, optimize class files includes updating and installing changes to applications with respect to capabilities, and program classes.

At block 515 additional scanning may be performed by process 500 to load a second set of applications. By scanning applications packages separately in blocks 505 and 515, the time for booting an operating system of a digital television may be reduced with respect to the time required to present display content.

FIG. 6 depicts digital television operation according to one or more additional embodiments. Process 600 depicts a graphical representation of a boot process of a digital television. Process 600 may be initiated by power on at block 605. At block 610, a firmware interface begins the boot process to perform one or more of selecting the software image to be loaded, checking the image for integrity and software decompression. At block 610 the operating system is decompressed and loaded based on software selected by the firmware interface. Loading the Operating System at block 615 may optionally include performing a file optimization for applications identified during one or more scans. In certain embodiments, the optimization is performed when there are changes to applications such as updates or on first boots of the television. Optimization may allow for compiling programs associated with applications into one or more program files configured for the operating system.

According to one embodiment, process 600 is associated with a multi-core processor (e.g., dual core, quad core, etc.). Accordingly, firmware interface block 610 and operating system block 615 may each contribute to hardware components (e.g., devices) recognizing the CPU so that the devices can instruct the CPU regarding processing needs and also for syncing hardware devices with the CPU. At block 615, the operating system recognizes more than one core, and allows for software programs (including applications) the ability to synchronize with cores when necessary. In one embodiment, threading is employed during the boot process and operation of the digital television such that software and hardware of the digital television are coded to provide information to each core (e.g., cores 325₁₋ₙ of the CPU, such that each core is used for a separate purpose.

In block 620, a first set of applications (e.g., “A applications”) are scanned. In block 625, a second set of applications (e.g., “B applications”) are scanned. FIG. 6 also depicts presentation of digital television at block 630 at about 1-1.5 seconds following detection of power on. Scanning of B applications at block 625 are completed at about 3-5 seconds. Presented digital television at block 630 may be based on acquisition of previous channel and decoding content for presentation of digital television 1-1.5 seconds. It should be appreciated that time values identified in FIG. 6 are exemplary and may be reduced or modified depending on the number of applications scanned, operating system to be loaded, etc.

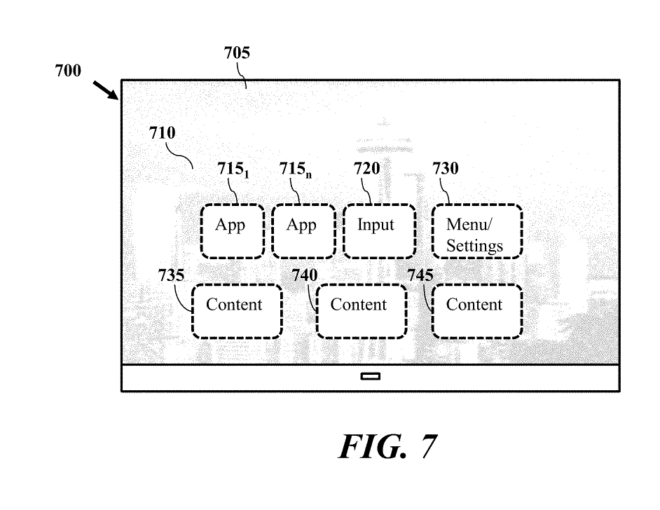

FIG. 7 depicts a graphical representation of a digital television according to one or more embodiments. Digital television 700 includes display 705 (e.g., LED, LCD, etc.) configured to present image content 710 based on content received by digital television 700. According to one embodiment, digital television 700 may be configured to operate to provide a boot operation including multiple package scanning similar to the boot process discussed above.

According to one embodiment, applications associated with one or more of the first and second scans can be associated with graphical elements presented by a digital television. Digital television includes an exemplary display including graphical elements 715₁₋ₙ associated with applications, graphical element 720 to view/select inputs, graphical element 730 for menu settings, graphical elements 735, 740 and 745 associated with content titles. According to one embodiment, graphical elements of FIG. 7 may be based on scanning of a first and second set of applications. As such, the boot process and configuration of the digital television allows for presentation of elements based on multiple stages of scanning

While this disclosure has been particularly shown and described with references to exemplary embodiments thereof, it will be understood by those skilled in the art that various changes in form and details may be made therein without departing from the scope of the claimed embodiments.

What is claimed is:

1. A method for digital television operation, the method comprising:
detecting, by the digital television, a command to power up the digital television;
running, by the digital television, a boot process for the digital television in response to the command;
performing, by the digital television, a scan of a first set of applications of the digital television during the boot process;
presenting, by the digital television, a display output at completion of the boot process; and
performing, by the digital television, a scan of a second set of applications of the digital television following presentation of the display output.

2. The method of claim 1, wherein the command to power up the digital television is received by the digital television in one of a low-power and off state of the digital television.

3. The method of claim 1, wherein the boot process loads an operating system of the digital television.

4. The method of claim 1, wherein the scan of the first set of applications is a package scan of a subset of applications to determined capabilities available to the operating system associated with the first set of applications.

5. The method of claim 1, wherein the first set of applications are identified in an executable configuration file stored in memory of the digital television and processed during the boot process.

6. The method of claim 1, wherein presentation of content includes display of image data associated with a source of input of the digital television and wherein presentation of the content indicates operability of the television.

7. The method of claim 1, wherein presentation of content includes presentation of graphical elements associated with one or more applications associated with the first set of applications.

8. The method of claim 1, wherein the second set of applications are non-essential applications.

9. The method of claim 1, wherein running the boot process and performing a scan of the first set of applications are performed are least in part in parallel.

10. The method of claim 1, further comprising presenting graphical elements by the digital television for the first set of applications and the second set of applications.

11. A digital television comprising:
a display;
a processor coupled to the display, the processor configured to
detect a command to power up the digital television;
run a boot process for the digital television in response to the command;
perform a scan of a first set of applications of the digital television during the boot process;
present a display output at completion of the boot process; and
perform a scan of a second set of applications of the digital television following presentation of the display output.

12. The device of claim 11, wherein the command to power up the digital television is received by the digital television in one of a low-power and off state of the digital television.

13. The device of claim 11, wherein the boot process loads an operating system of the digital television.

14. The device of claim 11, wherein the scan of the first set of applications is a package scan of a subset of applications to determined capabilities available to the operating system associated with the first set of applications.

15. The device of claim 11, wherein the first set of applications are identified in an executable configuration file stored in memory of the digital television and processed during the boot process.

16. The device of claim 11, wherein presentation of content includes display of image data associated with a source of input of the digital television and wherein presentation of the content indicates operability of the television.

17. The device of claim 11, wherein presentation of content includes presentation of graphical elements associated with one or more applications associated with the first set of applications.

18. The device of claim 11, wherein the second set of applications are non-essential applications.

19. The device of claim 11, wherein running the boot process and performing a scan of the first set of applications are performed are least in part in parallel.

20. The device of claim 11, further comprising presenting graphical elements by the digital television for the first set of applications and the second set of applications.
